(19) United States
(12) Patent Application Publication
(10) Pub. No.: US 2025/0055556 A1
(43) Pub. Date: Feb. 13, 2025

(54) MESH-BASED ACCESS NODES FOR MMWAVE AND RELAY COVERAGE

(71) Applicant: Cisco Technology, Inc., San Jose, CA (US)

(72) Inventors: Humberto Jose La Roche, Ocean, NJ (US); Ahmed Mohamed Ahmed Abdelsalam, L'Aquila (IT); Jakub Horn, San Jose, CA (US)

(21) Appl. No.: 18/601,903

(22) Filed: Mar. 11, 2024

Related U.S. Application Data
(60) Provisional application No. 63/518,212, filed on Aug. 8, 2023.

(51) Int. Cl. H04B 7/155; H04B 7/0426; H04L 45/24

(52) U.S. Cl. CPC H04B 7/15507; H04B 7/043; H04L 45/24

(57) ABSTRACT

The present disclosure is directed to a mesh gNB architecture enabled by SRv6 in which the mesh itself is a single logical gNB. The mesh can adapt to the Radio Frequency (RF) environment, leveraging a mix of physical layer links, including self-backhaul and other media to bypass RF obstacles and reach locations that would otherwise be blocked for coverage. In one aspect, a mesh-based radio access node includes one or more donor nodes and one or more relay nodes. Each of the one or more donor nodes and the one or more relay nodes includes at least one SRv6 router, and the one or more donor nodes and the one or more relay nodes are configured to communicate over a combination of wired and self-backhaul channels.

### CROSS-REFERENCE TO RELATED APPLICATIONS

This application claims priority to U.S. Provisional Patent Application No. 63/518,212, filed Aug. 8, 2023, the entire content of which is incorporated herein by reference.

### FIELD OF THE TECHNOLOGY

The present disclosure generally relates to wireless communication systems. Specifically, the proposed technology relates to a new mesh-type access point architecture that enables densification at mmWave through a combination of self-backhaul and fiber metallic, or microwave media. The proposed architecture can leverage SRv6 capabilities for data transport.

### BACKGROUND

The demand for faster data rates, greater capacity, and seamless connectivity has led to the rapid evolution of wireless communication networks. Millimeter-wave (mmWave) technology can play an important role in meeting these demands by providing broader bandwidths for enhanced data transfer rates. At current emission levels (EIRP) allowed by most regulators and current receiver sensitivities, mmWave appears to be a good fit for delivering high throughput at short distances (e.g., 300 m-1 km range) but use cases have been hindered by poor propagation characteristics that result in an inter-cell site distance of ˜200 m.

Operators are loathe to densify due to costs. For instance, each mmWave gNB requires a high-speed “backhaul” feed, typically fiber. In the United States, construction costs per fiber-mile ranges from $20 k (rural) to $200 k (metro). Therefore, the net result has been that fiber construction, site acquisition, and power have made business cases for mmWave very difficult to realize.

Therefore, a challenge faced by the industry is how to take advantage of new spectrum (mmWave) without having to change the existing cell-site grid, which has taken years to develop.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments, which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

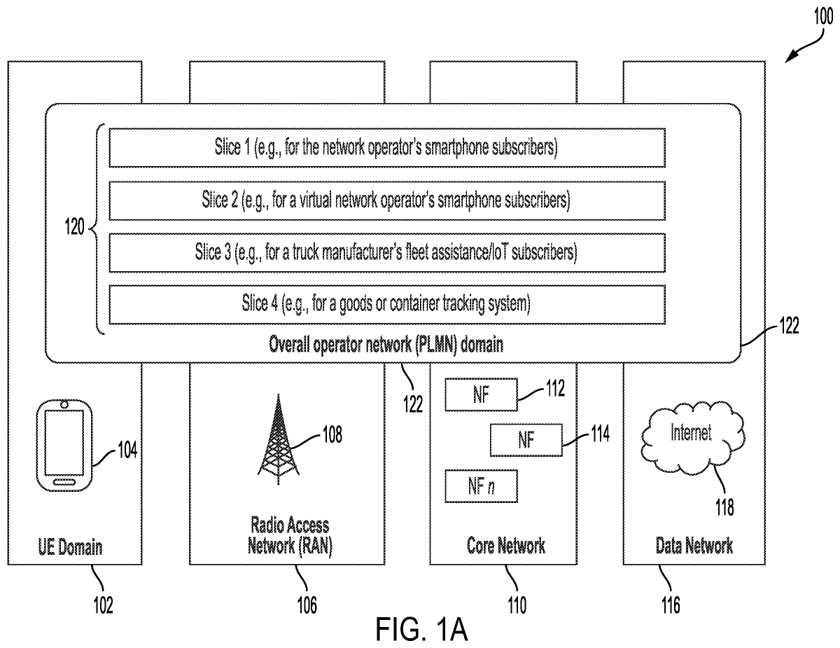

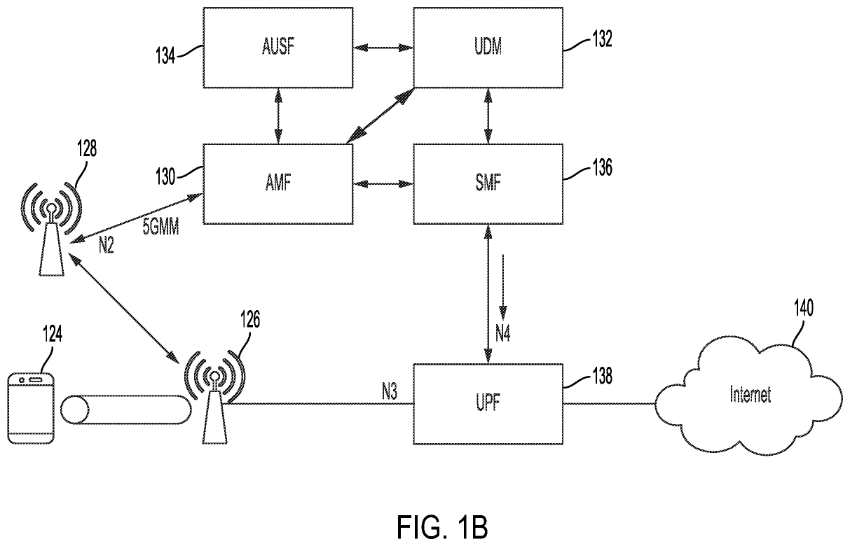

FIG. 1A depicts an example schematic representation of a 5G network environment according to some aspects of the present technology;

FIG. 1B illustrates an example 5G network architecture according to some aspects of the present technology;

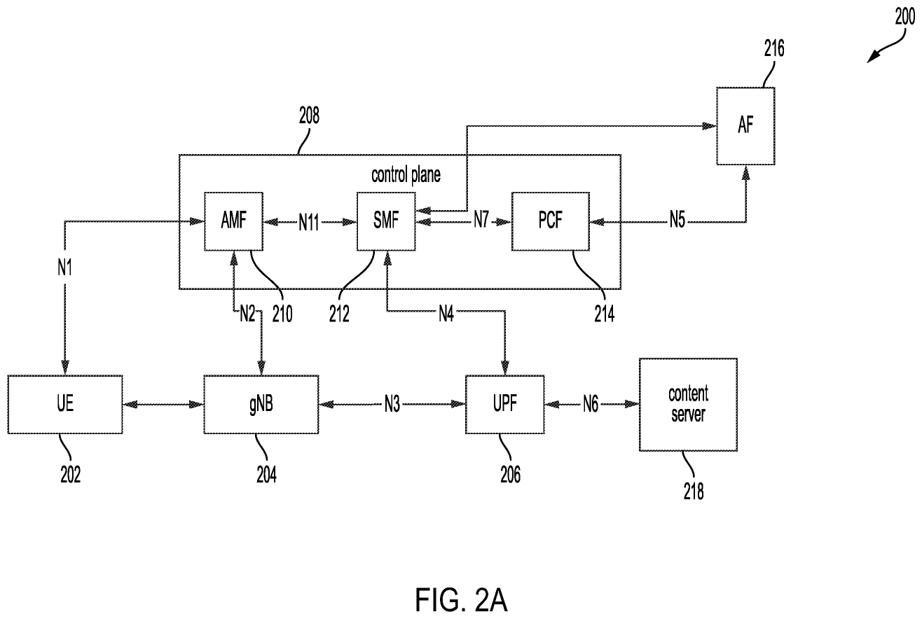

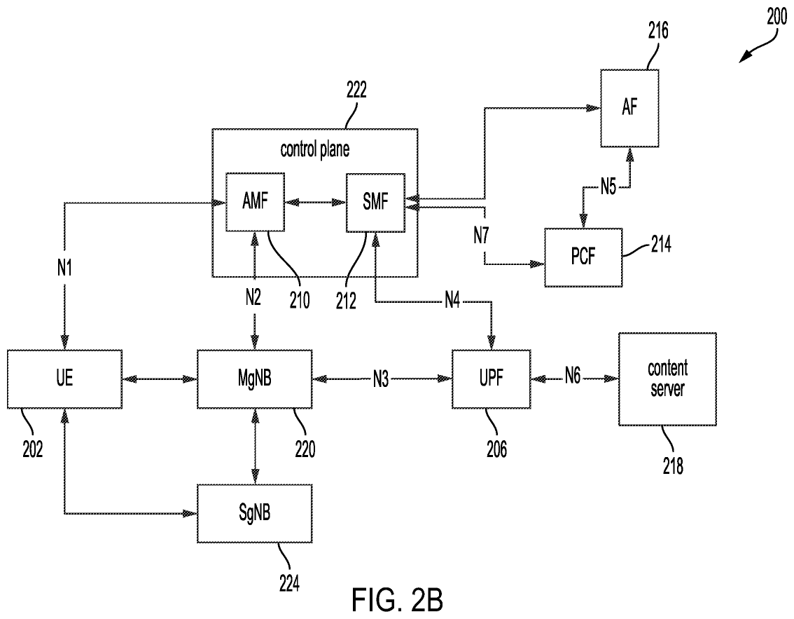

FIG. 2A illustrates an example of a data network according to some aspects of the present technology;

FIG. 2B illustrates an example of a data network with multiple radio access networks transmitting to a user equipment according to some aspects of the present technology;

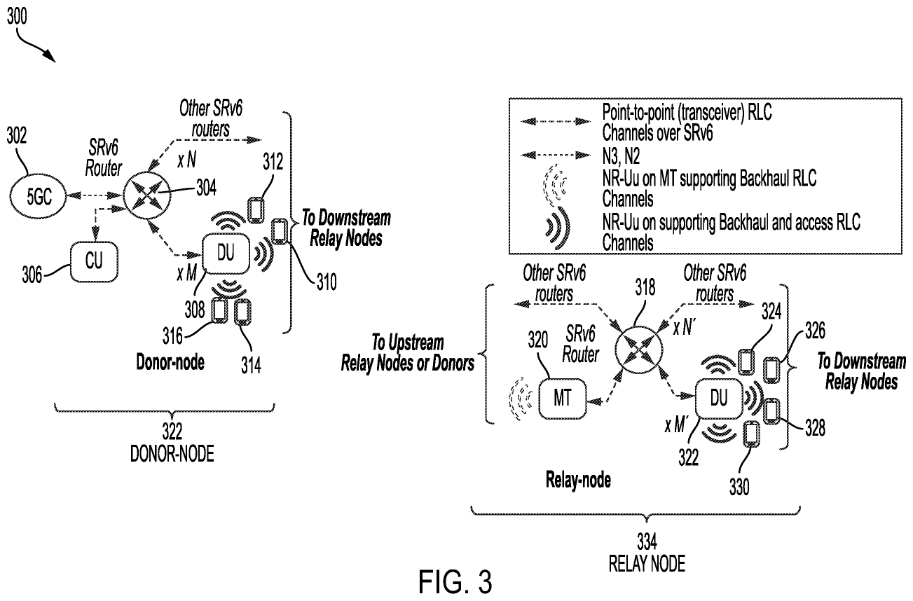

FIG. 3 illustrates an example model for an SRv6-based mesh gNB according to some aspects of the present technology;

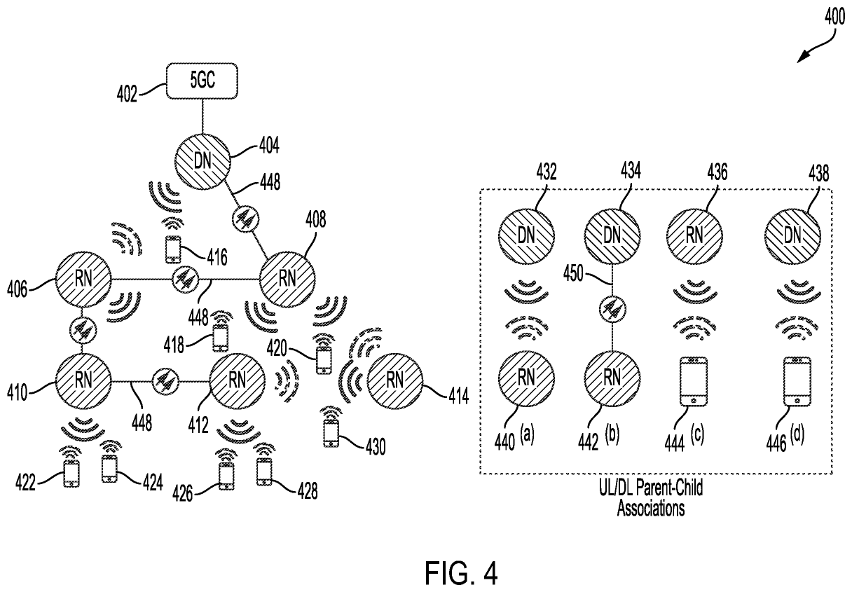

FIG. 4 illustrates an exemplary embodiment of a mesh gNB network according to some aspects of the present technology;

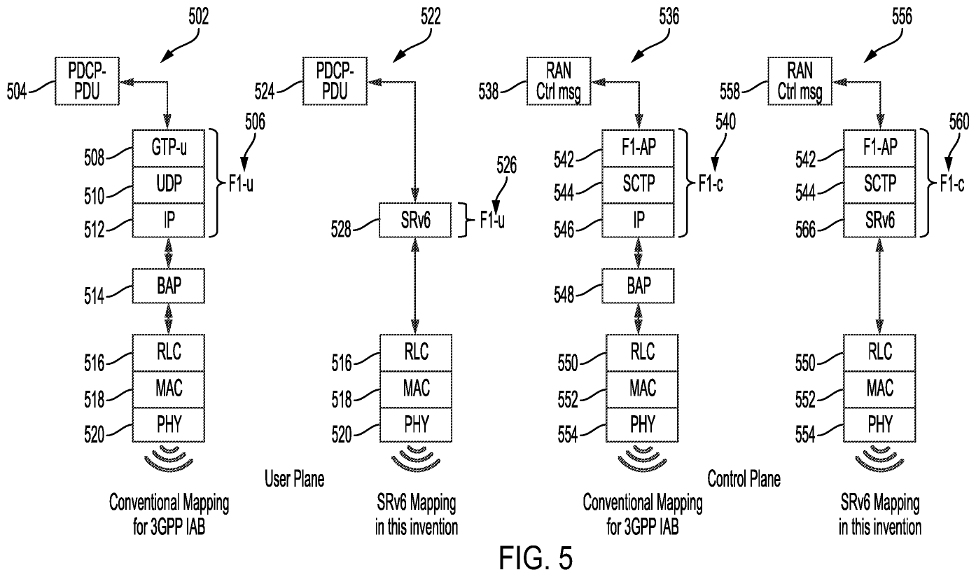

FIG. 5 illustrates protocol stack diagrams for a control plane and a user data plane to support 3GPP self-backhaul wireless interface in mesh-gNB architecture of FIGS. 3 and 4 according to some aspects of the present disclosure; and

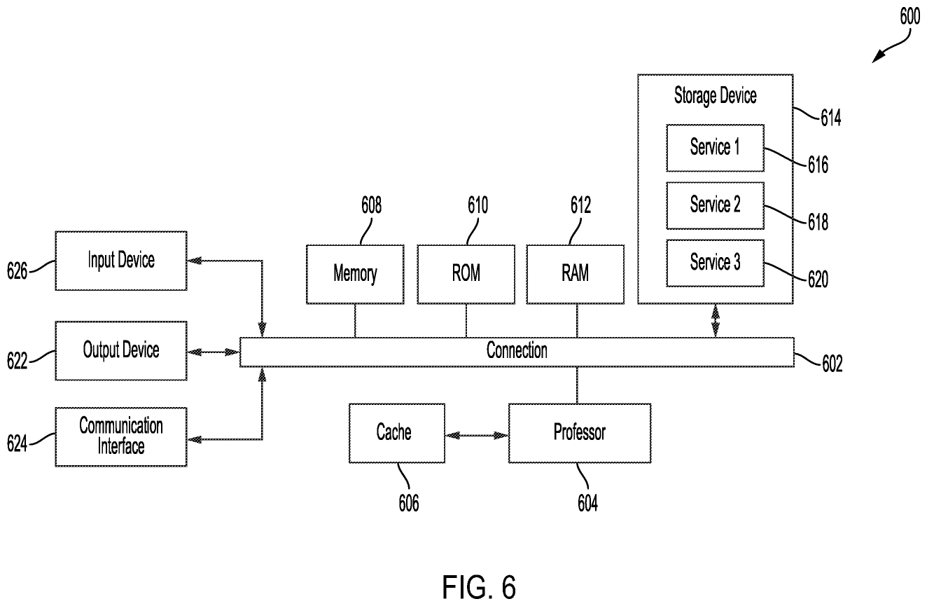

FIG. 6 illustrates an example of a computing system in accordance with certain embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### OVERVIEW

The present disclosure is directed to a distributed logical gNB with a mesh-based connectivity fabric comprised of multiple physical media. This logical gNB can adapt itself to the Radio Frequency (RF) environment, leveraging a mix of physical layer links, including self-backhaul and other media (fiber, copper, fixed wireless links), between the nodes that comprise the mesh, to bypass RF obstacles and reach locations that would otherwise be blocked for coverage. Such mesh-gNB can be a single operational entity. For instance, the Mesh-gNB has one (or two for redundancy) connections into the core network and intra mesh-gNB handovers do not expose any signaling to the core network. To accomplish this objective, ORAN/3GPP principles and techniques may be utilized.

In one aspect, a network access point includes a donor node including a central unit (CU) and at least one distributed unit (DU), wherein the CU is configured to perform functionalities associated with a first subset of layers of 5G signal processing layers and the at least one DU is configured to perform functionalities associated with a second subset of layers of the 5G signal processing layers. The network access point further includes a relay node including one or more mobile terminations (MTs) and one or more relay DUs. Each of the one or more MTs is configured to support a full signaling stack towards the one or more relay DUs. A top stack of each of the one or more MTs is a Radio Link Control (RLC) protocol configured to relay RLC Protocol Data Units (PDUs) to the one or more relay DUs and includes lower layers of the 5G signal processing layers. Each of the donor node and the relay node includes an SRv6-capable router to provide a mesh functionality such that the donor node and the relay node operate as the network access point for one or more user equipment.

In another aspect, the first subset of layers of the 5G signal processing stack includes service data adaptation protocol (SDAP) layer and packet data convergence protocol (PDCP) layer.

In another aspect, the second subset of layers of the 5G signal processing stack includes Radio Link Control (RLC) layer, Medium Access Control (MAC), and Physical PHY) layers.

In another aspect, each of the one or more MTs is configured to support a full signaling stack towards the one or more relay DUs.

In another aspect, a top stack of each of the one or more MTs is a Radio Link Control (RLC) protocol configured to relay RLC PDUs to the one or more relay DUs and includes the lower layers of the 5G signal processing stack.

In another aspect, the CU is configured to terminate traffic received at the CU from a 5G core; and include Radio Resource Control (RRC) signaling functions in communications with the one or more user equipment and the relay node.

In another aspect, each donor node is configured with one or more IPV6 addresses and a unique 10-bit BAP routing ID.

In another aspect, each relay node is configured with a unique 10-bit BAP routing ID, wherein the unique 10-bit BAP routing ID is received by the relay node via RRC signaling; and one or more IPv6 addresses acquired by the relay node during session establishment.

In another aspect, the donor node and the relay node are configured with an SRv6 policy that defines one or more hops and behaviors along a respective SRv6 router in each of the donor node and the relay node.

In another aspect, the behaviors are triggered upon receiving an incoming packet with a destination address (DA) matching a segment identifier (SID) identified on the respective SRv6 router.

In one aspect, a mesh-based radio access node includes one or more donor nodes and one or more relay nodes. Each of the one or more donor nodes and the one or more relay nodes includes at least one SRv6 router, and the one or more donor nodes and the one or more relay nodes are configured to communicate over a combination of wired and self-backhaul channels.

In another aspect, each of the one or more donor nodes includes a central unit (CU) and at least one distributed unit (DU), wherein the CU is configured to perform functionalities associated with a first subset of layers of 5G signal processing layers and the at least one DU is configured to perform functionalities associated with a second subset of layers of the 5G signal processing layers.

In another aspect, each of the one or more relay nodes includes one or more MTs and one or more relay DUs.

In another aspect, each of the one or more MTs is configured to support full 5G signaling stack.

In another aspect, each of the one or more MTs does not support any application function.

In another aspect, each of the one or more MTs is configured to support the full signaling stack towards the one or more relay DUs, and a top stack of each of the one or more MTs is a Radio Link Control (RLC) protocol configured to relay RLC PDUs to the one or more relay DUs and includes lower layers of 5G signal processing layers.

In another aspect, the one or more relay nodes are configured to prevent self-interference by performing time-domain separation of one or more transmitter and receiver duty cycles.

In another aspect, the one or more relay nodes are configured to prevent self-interference using one of beamforming or null forming at each of the one or more relay nodes.

In another aspect, the one or more donor nodes are configured to communicate with a 5G core.

In another aspect, the mesh-based radio access node includes two donor nodes configured to provide redundant connectivity to a 5G core.

### DESCRIPTION OF EXAMPLE EMBODIMENTS

The new greenfield higher frequency bands (e.g., mmWave) available in 5G and new ones expected for 6G provide reduced coverage and in consequence, are more expensive to deploy when compared to lower frequency spectrum for the same target coverage area. The higher cost is largely due to the need for densification which will often require fiber-based backhaul transport which is often not available. Fiber, while preferred, is expensive to deploy, as noted above. On the other hand, the abundant spectrum available at higher frequencies makes it possible to use self-backhaul: a concept wherein the service spectrum itself is used to connect radio transmission points.

3GPP has such an architecture known in standards as Integrated Access and Backhaul (IAB). IAB does not bode well in support of mesh or mixing of connectivity types (e.g., fiber, copper, self-backhaul). Absence of a mesh architecture is a consequence of 3GPP principles that define different functions for a User Equipment (UE) stack vs a base station stack and hence restrict topologies to “tree-and-branch” (e.g., Directed Acyclic Graph (DAG)).

Example embodiments described below solve this problem through a mesh gNB architecture enabled by SRv6 in which the mesh itself is a single logical gNB. The mesh adapts itself to the Radio Frequency (RF) environment, leveraging a mix of physical layer links, including self-backhaul and other media (fiber, copper, fixed wireless links), between the nodes that comprise the mesh, to bypass RF obstacles and reach locations that would otherwise be blocked for coverage. Such mesh-gNB can be a single operational entity. For instance, the Mesh-gNB has one (or two for redundancy) connections into the core network and intra mesh-gNB handovers do not expose any signaling to the core network. To accomplish this objective, Open Radio Access Network (ORAN)/3GPP principles and techniques may be utilized.

Mesh networks represent a sophisticated and resilient communication architecture characterized by a decentralized topology, wherein nodes collaborate to relay data, creating a self-organizing and fault-tolerant network. These networks offer superior coverage and reliability, making them particularly advantageous where traditional centralized infrastructures may face challenges. The utilization of millimeter-wave (mmWave) frequencies in mesh networks is a strategic advancement, leveraging frequencies above 24 GHZ, including bands around 28 GHZ, 39 GHz, and 60 GHz.

The flexibility defined as part of the gNB-mesh architecture, presented herein, extends the concept of a repeater, and addresses the problem of lowering the cost of covering a service area with high-band and high-throughput service such as mmWave, by adding SRv6 and using the IAB control plane as described in 3GPP standards.

Prior to describing example embodiments of the proposed gNB-mesh architecture, one or more examples of a 5G network (as a non-limiting example of a radio access network in which the proposed gNB-mesh architecture of the present disclosure may be applied), will be described with reference to FIGS. 1A-B and 2A-B.

FIG. 1A depicts an exemplary schematic representation of a 5G network environment according to some aspects of the present technology. In some examples, the 5G network environment 100 can be utilized to implement a cloud-based network, a fog computing architecture, etc.

As illustrated, network environment 100 is divided into four domains, each of which will be explained in greater depth below; a User Equipment (UE) domain 102, e.g. of one or more enterprises, in which a plurality of user cellphones or other connected devices 104 reside; a Radio Access Network (RAN) domain 106, in which a plurality of radio cells, base stations, towers, or other radio infrastructure 108 resides; a Core Network 110, in which a plurality of Network Functions (NFs) 112, 114, . . . , n reside; and a Data Network 116, in which one or more data communication networks such as the Internet 118 reside. Additionally, the Data Network 116 can support SaaS providers configured to provide SaaSs to enterprises, e.g., to users in the UE Domain 102.

In some example embodiments, core network 110 is a 5G core network (5GC) in accordance with one or more accepted 5GC architectures or designs, or an Evolved Packet Core (EPC) network, which combines aspects of the 5GC with existing 4G networks. Core Network 110 contains a plurality of Network Functions (NFs), shown here as NF 112, NF 114 . . . . NF n, which executes in a control plane of core network 110. The NFs are configured to provide a service-based architecture in which a given NF allows any other authorized NFs to access its services across any of the Network Slices 120 or as a unique instance. The plurality of NFs of the core network 110 includes one or more of Access and Mobility Management Functions (AMF) (typically used when core network 110 is a 5GC network); Mobility Management Entities (MME) (typically used when core network 110 is an EPC network); User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs).

In some example embodiments, an AMF/MME can be common to or otherwise shared by multiple slices of the plurality of Network Slices 120, and in some example embodiments an AMF/MME can be unique to a single one of the plurality of Network Slices 120. In some examples, the NFs can include a Session Management Function (SMF) that controls session establishment, modification, release, etc., and in the course of doing so, provides other NFs with access to these constituent SMF services.

Various other NFs can be provided without departing from the scope of the present disclosure, as would be appreciated by one of ordinary skill in the art.

Across the four domains of the 5G network environment 100, an overall operator Network Domain 122 is defined. The operator Network Domain 122 is in some example embodiments a Public Land Mobile Network (PLMN), a private 5G network and/or a 5G enterprise network and can be thought of as the carrier or business entity that provides cellular service to the end users in UE Domain 102. Within the operator Network Domain 122, a plurality of Network Slices 120 are created, defined, or otherwise provisioned in order to deliver a desired set of defined features and functionalities, e.g., SaaSs, for a certain use case or corresponding to other requirements or specifications. Note that network slicing for the plurality of Network Slices 120 is implemented in end-to-end fashion, spanning multiple disparate technical and administrative domains, including management and orchestration planes (not shown). In other words, network slicing is performed from at least the enterprise or subscriber edge at UE Domain 102, through the RAN 106, through the 5G access edge and the 5G core network 110, and to the Data Network 116. Moreover, note that this network slicing may span multiple different 5G providers.

Within the scope of the 5G mobile and wireless network architecture, a network slice comprises a set of defined features and functionalities that together form a complete Public Land Mobile Network (PLMN), a private 5G network and/or a 5G enterprise network for providing services to UEs. This network slicing permits for the controlled composition of the 5G network with the specific network functions and provided services that are required for a specific usage scenario. In other words, network slicing enables a 5G network operator to deploy multiple, independent 5G networks where each is customized by instantiating only those features, capabilities and services required to satisfy a given subset of the UEs or a related business customer need.

For example, as shown here, the plurality of Network Slices 120 include Slice 1, which corresponds to smartphone subscribers of the 5G provider who also operates network domain, and Slice 2, which corresponds to smartphone subscribers of a virtual 5G provider leasing capacity from the actual operator of Network Domain 122. Also shown is Slice 3, which can be provided for a fleet of connected vehicles, and Slice 4, which can be provided for an IoT goods or container tracking system across a factory network or supply chain. Note that these Network Slices 120 are provided for purposes of illustration, and in accordance with the present disclosure, and the operator Network Domain 122 can implement any number of network slices as needed, and can implement these network slices for purposes, use cases, or subsets of users and user equipment in addition to those listed above. Specifically, the operator Network Domain 122 can implement any number of network slices for provisioning SaaSs from SaaS providers to one or more enterprises, to facilitate efficient management of SaaS provisioning to the enterprises.

FIG. 1B illustrates an example 5G network architecture according to some aspects of the present technology. As addressed above, a UE 124 (can be the same as connected devices 104) can connect to a radio access network provided by a first gNodeB (gNB) 126 or a second gNB 128.

The gNB 126 can communicate over a control plane N2 interface with an access mobility function (AMF) AMF 130. AMF 130 can handle tasks related to network access through communication with a unified data management (UDM) function 132. Collectively, AMF 130 and UDM 132 can determine whether a UE should have access and if any parameters related to the access should be applied. Accordingly, the AMF 130 utilizes the UDM 132 to retrieve any access-based information or restrictions of the UE 124. AMF 130 also works with AUSF 134 to handle authentication and re-authentication of the UE 124 as it moves between access networks. The AUSF 134 and the AMF 130 could be separated or co-located.

Assuming AMF 130 determines the UE 124 should have access to a user plane to provide voice or data communications, AMF 130 can select one or more service management functions (SMF) 136. SMF 136 can configure and control one or more user plane functions (UPF) 138. UPF 138 may provide connectivity for UE 124 towards Internet 140. AUSF 134 can provide a security key to SMF 136 for use in encrypting control plane communications between the SMF 136 and the gNB 126/gNB 128, via the UPF 138. For example, the SMF 136 can configure UPF 138, acting as a router, with traffic classification rules and traffic policies for the IP address.

As noted above SMF AMF 130 can configure and control one or more user plane functions (UPF) 138. SMF 136 communicates with UPF 138 over an N4 Interface which is a bridge between the control plane and the user plane. SMF 136 can send PDU session management and traffic steering and policy rules to UPF 138 over the N4 interface. UPF 138 can send PDU usage and event reporting to SMF 136 over the N4 interface, and also communicate user plane data or voice over the N3 interface back to UE 124 through gNB 126.

FIG. 2A illustrates an example of a data network according to some aspects of the present technology. FIG. 2A illustrates a network 200 that includes a user equipment (UE) 202, a next generation NodeB (gNB) 204, a user plane function (UPF) 206, a control plane 208 (which includes an access and mobility management function (AMF) 210, a session management function (SMF) 212, a policy control function (PCF) 214), an application function (AF) 216, and a content server 218.

According to certain non-limiting examples, embodiments, and implementations, the network 200 can be a 5G wireless network 200 in which embodiments presented herein may be imple-mented. The network 200 may include a number of network nodes and/or entities, such as a user equipment (UE) device 202 (referred to simply as “UE” or “the UE”), e.g., a mobile telephone. The network 200 may be, for example, an enterprise private Third Generation Partnership project (3GPP) based network, such as a private Fifth Generation (5G) network for “private 5G.” Such enterprise deployments may have mis-sion-critical devices, Internet of Things (IoT) devices, and/or robotics devices, where application-specific Quality of Service (QOS) treatment, low latency, and reliability are key considerations.

It will be appreciated that the network 200 typically includes multiple UE devices; however, one UE is depicted for simplicity. The UE 202 may be any suitable type of device, such as a cellular telephone, a smart phone, a tablet device, an IoT device, a Machine-to-Machine (M2M) device, a robotics device, and a sensor, etc. UE 202 may obtain access to the private 5G network via one or more base stations, such as a gNB 204.

In the non-limiting example in FIG. 2A, the network 200 is illustrated with the gNB 204 being a next generation NodeB (gNB), but it is understood that, instead of using a gNB as the radio access network (RAN), the network 200 may be implemented using, as an RAN, one or more of an evolved universal mobile telecommunications system (UMTS) terrestrial radio gNB (E-UTRAN), a radio area network, and/or a next generation radio area network (NG-RAN) (each more generally referred to as a “RAN”). The gNB 204 may include one or more eNodeB (eNB) entities and/or one or more next generation NodeB (gNB) devices. The eNB and gNB entities (more generally referred to as a “gNB”) may communicate with one another via one or more X2 (referred to as “Xn” in 5G) interfaces.

In the data plane, the network 200 also includes a UPF 206 and a content server 218. As discussed in more detail below, the data plane supports various methods for sending protocol data units (PDUs) from the content server 218 to the UE 202 to achieve ultra-reliability and low latency communication (URLLC). Some of these methods support redundant flows of traffic over portions of the transmission path from the content server 218 to the UE 202 (e.g., copies of the same PDUs are sent along various legs of the transmission path). Thus, the UE 202 or gNB 204 may receive duplicate flows of packets/PDUs, such that when packets are dropped along a given leg of the transmission path due, e.g., to network problems, the UE 202 continues to receive at least one copy of the dropped packets/PDUs, to achieve URLLC.

In addition to the data plane of the network 200 over which flows of traffic are conveyed between the UE 202 to the content server 218, the network 200 also includes a control plane 208 to manage/control the data plane. The network 200 may include one or more local area networks (LANs) and one or more wide area networks (WANs), such as the Internet.

Control planes of a control plane 208 may be utilized in the network 200 for access and mobility management, session management, and/or policy management and control for the UE 202. In particular, the control plane 208 may include an Access and Mobility Management Function (AMF) 210 and a Session Manage-ment Function (SMF) 212. The AMF 210 and SMF 212 may be implemented as separate functions or components, or alter-natively provided together as an integrated functionality (in whole or in part) and/or co-located at the same node or component. A protocol data unit (PDU) session at UPF 206 may be managed by SMF 212 over an N4 interface using a Packet Forwarding Control Protocol (PFCP), for example. In some imple-mentations, control plane 208 is provided locally in the network 200. In other implementations, control plane 208 is provided as part of a cloud infrastruc-ture. In some implementations, the private 5G network may be configured without use of a Policy and Control Function (PCF) 214.

UE 202 may communicate with access and mobility management function (AMF) 110 via the gNB 204. The AMF 210 may communicate control signaling (e.g., non-access stratum (NAS) signaling) with UE 202 using an N1 interface. The AMF 210 may commu-nicate control signaling with the gNB using an N2 interface. The AMF 210 may facilitate communication by other network functions with UE 202 and/or the gNB 204. For example, other network functions may subscribe to notifications regarding mobility events relating to UE 202. The AMF 210 may support termination of non-access stratum (NAS) signaling, NAS ciphering and integrity protection, registration management, connection management, and/or mobility management. The AMF 210 may support access, authentication, and authorization (AAA) and/or security context management.

The AMF 210 may communicate control signaling with a session management function (SMF) 112 using an N11 interface. The SMF 212 may support session establish-ment, modification, and/or release. The SMF 212 may allocate and manage the allocation of an internet protocol (IP) address to UE 202. The SMF 212 may support dynamic host configuration protocol (DHCP) functions. The SMF 212 may support termination of NAS signaling related to session management. The SMF 212 may support traffic steering configuration for one or more user plane functions (UPFs) 106. When multiple AMFs are present, they may communicate with each other over one or more N14 interfaces.

The UPF 206 may communicate control signaling with the SMF 212 using an N4 interface. If multiple UPF entities are present, they may communicate control signaling with each other using one or more N9 interfaces. The one or more UPF 206 may communicate data signaling with the gNB 204 using an N3 interface. The UPF 206 may support packet routing and forwarding, packet inspection, and han-dling of quality of service (QOS). The UPF 206 may act as an external protocol data unit (PDU) session point of interconnect to a content server 218, such as the Internet. The UPF 206 may communicate data signaling with the content server 218 using an N6 interface. The UPF 206 may serve as an anchor point for mobility within and between radio access technologies (RATs).

A policy control function (PCF) 214 may communicate control signaling with the SMF 212 using an N7 interface. The PCF 214 may communicate control signaling with the AMF 210 using an N15 interface. The PCF 214 may provide policy rules to other control plane entities. The PCF 214 may provide access subscription information for policy decisions in a unified data repository, for example.

An application function (AF) 216 may communi-cate control signaling with the PCF 214 using an N5 interface. The AF 216 may support application influence on traffic routing. The AF 216 may interact with the PCF 214 to provide policy control. In the ensuing description, control signaling, data signal, and NAS signaling may be referred to more generally as “signaling.”

FIG. 2B illustrates an example of a data network with multiple radio access networks transmitting to a user equipment according to some aspects of the present technology. Similar to FIG. 2A, FIG. 2B illustrates a non-limiting example of the network 200. In addition to the UE 202, the UPF 206, the AMF 210, the SMF 212, a PCF 214, the AF 216, and the content server 218, the network 200 illustrated in FIG. 2B, includes two radio access networks (i.e., a first/master next generation NodeB (MgNB) 220 and a second/secondary next generation NodeB (SgNB) 224). The MgNB 220 and the SgNB 224 have a same functionality as the gNB 204 in FIG. 2A, except there are two gNBs in FIG. 2B rather than one. This difference provides redundancy in case packets are dropped between one of the gNBs and the UE 202, to achieve URLLC.

Hereinafter, example embodiments of a mesh gNB architecture enabled by SRv6 will be described.

As alluded to above, 3GPP relays, known as IAB devices can provide an alternative to fiber backhaul in the mmWave spectrum. The basic principle of operation of the IAB is to use the same spectrum as used for a service to also transport the mid-haul F1 interface. An IAB is a single logical gNB comprised of many nodes, known as IAB-Nodes, rooted in an anchor known as an IAB-Donor. Because IABs inherit the ORAN and 3GPP decomposition, where Centralized Units (CUs) communicate only with Distributed Units (Dus) and not with other Dus, IABs are restricted to a tree and branch topology, a Spanning Tree (ST). Support is expanded to include DAG by adding the ability of an (a) IAB-Node to have two parent nodes, and (b) IAB-Node to home on two IAB-donors.

Comparatively, mesh topologies introduced in this disclosure provide more options for internal resiliency and self-healing than DAG. The resiliency is important considering Radio Link Failures (“RLF”) which are more likely in the frequency mmWave bands of interest. Furthermore, the mesh defined here is comprised of heterogenous physical links that can use any metallic, fiber, or wireless media. In this sense, a single logical gNB concept is expanded to go beyond self-backhaul or out-of-band backhaul.

The proposed architecture also satisfies two conditions. First, the architecture is IP-centric accomplished by using SRv6 and its ability to transport opaque data. In another example, the IP-centric architecture is supported by micro SIDs, which is an extension of SRv6. In this instance, instead of having IPv6 addresses to describe SRv6 policies, micro SIDs are used to describe an SRv6 policy. When using micro SIDs, 128 bits may be used to do 7 waypoints which decreases the overhead compared to using SRv6 only. Second, the architecture aligns with existing standards accomplished by re-using IAB F1-C control plane but applied to an SRv6 user plane modified to address the F1 interface.

FIG. 3 illustrates an example model for an SRv6-based mesh gNB according to some aspects of the present technology. Example architecture 300 can include a donor node 332 and a relay node 334. The number of relay nodes may be more than one. The donor node 332 includes a central unit (CU) 306 and one or more distributed units (Dus) 308.

The CU 306 in the donor node 332 includes functionalities of service data adaptation protocol (SDAP) layer and packet data convergence protocol (PDCP) layer in the 5G signal processing stack. In one example, CU 306 receives traffic, including a plurality of data flows from the 5GC 302, sent through a next-generation (NG) interface. The CU 306 further manages Radio Resource Control (RRC) signaling functions towards the served UEs (e.g., UEs 310, 312, 314, 316), and downstream relay nodes.

The DU 308 in the donor node 332 can include lower layers of the network resource scheduler (NRS) stack (e.g., Radio Link Control (RLC), Medium Access Control (MAC), and Physical PHY) layers).

The relay node 334 may include multiple MTs 320 and one or more distributed Dus 308. The MT 320 is a client device that is designed to provide a full signaling stack (e.g., 5G signaling stack) towards the Donor Node 322. In one example, MT 320 does not include any application functions. The top of the MT stack features an RLC implementation that relays RLC PDUs to the donor node 332 DU 308, which includes the lower layers of the NRS stack including the RLC, MAC, and PHY. The Donor Node 322 is subsequently able to serve and distribute data to a plurality of UEs 324, 326, 328, 330 and a plurality of downstream relay nodes.

The relay node 334 and donor node 332 may each be equipped with an SRv6-capable router such as routers 304 and 318 to enable mesh functionality. A micro-router, powered by a commercially available “router on a chip” ASIC like CiscoOne or equivalent merchant silicon, is typically used. The chip firmware may be programmed to introduce new SRv6 behaviors, replacing the BAP forwarding function in the IAB for improved versatility.

IPv6 with the extended header may be utilized to handle opaque payloads of various types. By implementing SRv6 behaviors, the donor node SRv6 router 304 and relay node SRv6 router 318 can direct traffic to RAN stack functions DU 308, 322, CU 306, or MT 320, as well as other SRv6 routers, making it possible to include mesh connectivity in the topology support. Each of routers 304 and 318 can establish connections with other SRv6 routers using various types of known or to be developed links (e.g., fiber optics, metallic, or point-to-point wireless links). In one example, a self-configuring link-state Interior Gateway Protocol (IGP) like ISIS or OSPFv3 can govern the default IPV6 routing behavior. The creation of SRv6 behaviors are inferred via the standard F1-C signaling.

According to the present disclosure, the definition of a DU, consistent with the 3GPP specifications defining the IAB, can include the Radio Unit (RU).

In some examples, the Donor-Node (e.g., donor node 332) can include multiple DUs. The Relay-Node (e.g., relay node 334) can include multiple MTs and multiple DUs.

Relay-Nodes can suffer from what may be referred to as self-interference which prevents simultaneous transmission/reception of timeslots. Self-interference can be cured at the expense of reduced throughput by coordinating UL and DL slots, so a relay is not transmitting at the same time as the relay is receiving. In some examples, with space-division multiplexing and beamforming commonly used at 5G mmWave, self-interference can be avoided.

FIG. 4 illustrates an exemplary embodiment of a mesh gNB network according to some aspects of the present technology. In the illustrated scenario in FIG. 4, a mesh gNB network is presented, integrating both fiber and self-backhaul within a unified architecture. The diagram reveals two potential interface types between the donor node and relay node. The first type is the self-backhaul interface, resembling IAB-style connectivity but utilizing SRv6 instead of BAP. The second type of interface leverages fiber, metallic, or other point-to-point connections and is identified as a transceiver interface (TXR). This interface can be facilitated by a transceiver like an SFP on the SRv6 router.

The mesh gNB architectures 400 shows two example configurations of a mesh-gNB. The example to the left includes a donor node 404, in communication with a 5GC 402, serving multiple relay nodes 406, 408, 410, 412, and 414. Each remote node is equipped with a base station interface configured to engage in communication via RF signals with the mobile device interfaces of various connected UEs (e.g., UEs 416, 418, 420, 422, 424, 426, 428, and 430).

As can be seen in the example to the left in FIG. 4, any two of the donor nodes 404 and the relay nodes 406, 408, 410, 412, and 416 may communicate via one or more of a wired link (e.g., fiber, metallic, or other point-to-point connections, as described above) and/or a wireless connection. This shows the use of two types of interfaces for self-backhaul and fiber connectivity that enables a resilient mesh-gNB network that can provide extended reliable connectivity in a service area with high-band and high-throughput service such as mmWave without having to build out additional physical structure to do so.

The establishment of an uplink/downlink parent-child association between a donor node 432, 434 and a remote node 440, 442 in a mesh gNB architectures 400 can be achieved through various communication links, including wireless connections, and wired connections such as fiber, metallic, or other point-to-point links (e.g., wired links 448).

In a wireless example, the donor node 432, communicates with the remote node 440 via 3GPP point-to-multipoint self-backhaul RF signals. This wireless link enables bidirectional data transfer, allowing the donor node 432 to act as an uplink parent, transmitting data to the remote node, and a downlink parent, receiving data from the remote node 440. The wireless communication link offers flexibility and adaptability, making it suitable for scenarios where physical connections are challenging or impractical.

Example to the right in FIG. 4 is another non-limiting variation for a mesh-gNB architecture with several donor nodes 432, 434, and 438, several relay nodes 436, 440, and 442 and UEs 444 and 446. Similar to the example to the left in FIG. 4, while the communication between a given one of UEs 444 and 446 and relay node 436 and donor node 438 may be wireless, the communication between any two of donor nodes 432, 434, and 438, and relay nodes 436, 440, and 442 may be wired (e.g., via link 450) or wireless, as described above.

3GPP TS 38.401 defines a user plane and a control plane communication protocol stack for IAB (§ 6.1.4 of TS 38.401). SRv6 simplification of the user-plane and control-plane stacks, according to aspects of the present disclosure will be described next.

FIG. 5 illustrates protocol stack diagrams for a control plane and a user data plane to support 3GPP self-backhaul wireless interface in mesh-gNB architecture of FIGS. 3 and 4 according to some aspects of the present disclosure.

User-Plane IAB Stack 502 shows the conventional user-plane stack for 3GPP IAB. As can be seen, User-Plane IAB Stack 502 has several layers, each with a specific role in facilitating reliable communication between donor and relay nodes. The sequence follows the order of PDCP-PDU 504, F1-u 506 including GTP-u layer 508, UDP layer 510, and IP layer 512), BAP layer 514, RLC layer 516, medium access control (MAC) layer 518, and PHY layer 520.

The PDCP-PDU 504 assumes responsibility for ensuring the integrity and reliability of user data. The PDCP-PDU 504 accomplishes this through error correction, header compression, and ciphering, preparing the data for subsequent transmission over the F1-u 506 interface.

The F1-u 506, encompassing GTP-u layer 508, UDP layer 510, and IP layer 512, collectively orchestrates the transport of user data across the F1-u 506 interface. GTP-u layer 508 handles the tunneling of user data, while UDP layer 510 provides a lightweight communication mechanism, and IP layer 512 ensures proper routing and addressing within the network.

The BAP layer 514 establishes bidirectional associations between the IAB-DU and the IAB donor-CU. This layer ensures synchronization and coordination for managing the bidirectional flow of data in the IAB architecture.

The RLC layer 516 manages the reliable transmission of data over the radio link, incorporating error correction, retransmission, and segmentation to uphold the integrity of communication between the IAB-DU and the IAB-donor CU.

The MAC layer 518 provides access to the shared radio medium. It coordinates the transmission and reception of data frames, managing protocol timing and channel access to optimize the use of the radio spectrum.

At the bottom of the stack, the PHY layer 520 facilitates the physical transmission and reception of data. Whether through radio waves or wired connections, this layer translates digital information into analog signals for transmission and vice versa, completing the end-to-end communication process.

User-Plane SRv6 stack 522 illustrates an example of SRv6-based simplification of User-Plane IAB Stack 502 according to some aspects of the present disclosure. As can be seen, F1-u 506 stack comprising of GTP-u layer 508, UDP layer 510, and IP layer 512 as well as BAP layer 514 in User-Plane IAB Stack 502 is replaced with a single SRv6 layer 528 in User-Plane SRv6 Stack 522. PDCP-PDU 524 is the same as PDCP-PDU 504. F1-u 526 is the same as F1-u 506.

In control-plane IAB stack 536, the protocol stack unfolds in a sequence of layers, each designed to facilitate communication and control functions among network elements. Beginning with the Radio Access Network (RAN) Control Message 538, a control plane communication is initiated by carrying messages integral to control and management functions within the radio access network. These messages can trigger a whole host of actions and decisions throughout the control plane.

F1-c 540 encompasses the F1 Application Protocol (F1-AP) layer 542, Stream Control Transmission Protocol (SCTP) layer 544, and IP layer 512, with each layer contributing to the control plane's signaling and management. F1-AP layer 542 manages specific signaling and control functions related to the F1-c 540 interface, while SCTP layer 544 ensures dependable, connection-oriented communication between F1-c 540 and the BAP layer 548. The IP layer 512 provides the addressing and routing framework for control plane messages, facilitating their delivery within the network.

The BAP layer 548, establishes bidirectional associations between F1-c 540 and BAP layer 548 in the control plane. The BAP layer 548 synchronizes and coordinates communication, fostering the integrated access and backhaul architecture's cohesive functioning. The RLC layer 550 in the control plane takes charge of control information related to the radio link. It ensures the reliability and integrity of control procedures, working in coordination with the BAP layer 548. The MAC layer 552 governs access to the shared radio medium in the control plane. It coordinates the transmission and reception of control frames, managing timing, and access protocols to optimize the radio spectrum's utilization. Finally, the PHY layer 554 in the control plane handles the transmission and reception of control-related raw bits over the physical medium.

Control-Plane SRv6 Stack 556 illustrates an example of SRv6-based simplification of Control-Plane IAB Stack 536 according to some aspects of the present disclosure. As can be seen, IP layer 546 and BAP layer 548 are replaced with a single SRv6 layer 566 in Control-Plane SRv6 Stack 556. Radio Access Network (RAN) Control Message 558 is the same as Radio Access Network (RAN) Control Message 538. F1-c 560 is the same as F1-c 540.

The benefits of adopting SRv6 in both control and user planes extend beyond simplification. SRv6 introduces a programmable and flexible approach to routing, allowing for dynamic adaptation to changing network conditions. SRv6 provides enhanced network programmability, making it easier to deploy and manage services within the network infrastructure. Additionally, SRv6 brings in-network telemetry capabilities, enabling operators to gain valuable insights into network performance and troubleshoot issues more effectively.

In the context of a radio relay architecture, service function chains (SFC) can be implemented in various ways to build an advanced 3GPP radio relay architecture that can interconnect donor nodes and relay nodes using CUs, DUs, MTs, using SRv6 technology, as disclosed herein. For instance, SRv6 SFC may deploy one or more classifier ingress nodes to classify incoming packet flows based on their characteristics and may apply different steering policies accordingly. In this architecture, steering is done through SRv6 policies, in the form of a binding SID (BSID), which are configured as policy rules by the RAN control plane. The CU and ingress MT can act as classifiers in this service function chain.

The SRv6 behaviors described herein can correspond to traffic steering in SFC. These behaviors can be triggered on ingress to the SRv6 domain or when an incoming packet has a Destination Address (“DA”) that matches a configured SID on a router. If there is no matching SID, then the SRv6 router performs DA-based next-hop forwarding controlled by the routing protocol according to SRv6 protocols. If there is a matching SID, the application-specific end-point behaviors is triggered. Upon completion of the end-point behavior (e.g., a specific 5G stack function), an egress packet may be created with the appropriate SRH and presented back to the SRv6 router. In short, the RAN implemented using SRv6 is a service graph where CU, DU, and MT are service function nodes that apply 5G functions to the network traffic.

One or more examples will now be described to integrate application functions used in the gNB-relay architecture of the present disclosure (e.g., DU, CU, MT) into an SRv6 SFC. In the SRv6 SFC architecture, service functions can be SRv6-aware or SRv6-unaware. SRv6-aware service functions are those that can natively process SRv6 traffic whereas SRv6-unaware functions are those that cannot. In the case of SRv6-aware services, the service function directly receives the SRv6 packet, processes the SR information in the packet, performs the functions on the payload as specified by the SID, and then uses the specified forwarding treatment on the SID to send the packet towards the next SID. SRv6 aware service functions can directly process Endpoint SIDs (ESID). On the other hand, SRv6-unaware functions can utilize a proxy to process incoming flows to remove the SRv6 headers and then add an appropriate header for outgoing packets. The combination of an SRv6-unaware service and a proxy defines an SRv6-aware service. Hence, it suffices to focus on SRv6-aware service functions as this covers the general case when an application function plus proxy is considered. From a development engineering point of view, a conventional application function can be enhanced with a proxy and become functional in the mesh-gNB architecture.

In the mesh-gNB architecture disclosed herein, the RAN control plane including IAB functions may remain unchanged so the F1-AP and RRC protocols as used in Rel-16 for IAB can be used. In other words, instead of configuring a BAP sublayer with BAP-address forwarding, the IAB control plane configures an SRv6 sublayer with SRv6 behaviors. To do so, the following steps may occur.

Each Donor-node can have:
One or more configured IPv6 addresses (e.g., an address used by F1-C signaling), and
A unique 10-bit BAP routing ID.

Each Relay-node can have:
A unique address which is the 10-bit BAP Routing ID defined and is provided to the Relay-node using Rel-16 RRC signaling.
An IPV6 address (or addresses) acquired from the OAM PDU Session established when the relay node self-configures, which may be the same as described for an IAB per TS § 8.9.13 in 38.401.

An SRv6 Policy, configured by the F1-c (unchanged from 3GPP), can indicate the “hops” and “behaviors” along SRv6 routers embedded in each node type.

When an F1 packet enters the RAN SRv6 sublayer, a Binding SIDs (“BSID”) is applied and subjected to Behaviors configured in the SRv6 routers. A packet exits the SRv6 sublayer when a BAP address embedded in the packet matches a BAP-to-IP mapping table established via F1 signaling. The SRv6 sublayer is established between the Donor Node and serving Relay Node to a UE (e.g., the Relay Node providing service to a UE). These are terminal nodes supporting entry/egress into the SRv6 service graph and apply Binding SIDs established via control plane procedures inherent to the RAN.

The traffic steering function into a service function is triggered when an incoming packet has a Destination Address (“DA”) that matches a configured SID on the router. If there is no matching SID, then the SRv6 router performs DA-based next-hop forwarding.

The Donor-node supports the interface to the mobile core which can be 3GPP standard N3, N2, and/or newer known or to be developed concepts for replacing GTP-u over UDP/IP with SRv6. Both EPC and 5GC can be supported. Donors may provide service to UEs and interface with downstream Relays via mid-haul F1 carried over the air using 5G 3GPP self-backhaul (e.g., NR-Uu) or any wired/wireless point-to-point media (fiber, copper, point-to-point mmWave radio) using transceiver interfaces (denoted by “link” such as links 448 and 450 in FIG. 4). Unlike the conventional IAB concept, multiple DUs and multiple links can be mixed in a system supporting the principles described herein. The Donor and Relay Nodes may deploy DUs supporting one or more cell sectors (or equivalently, one or more DUs each supporting a cell-sector). In some examples, multihoming to two CUs may also be used using New Radio Dual Connectivity (NRDC).
Self-Interference Mitigation

Within a Relay-node, transmitters may generally coexist with receivers. Since the transmitter is communicating with a remote node or a UE, a transmitter operating when a collocated receiver is operating can be problematic because of the interference generated by the transmitter on the receiver. There may be several ways to mitigate such interference. In one example, ensuring sufficient spatial separation between collocated transceivers can provide such mitigation. This approach of isolating transceiver interfaces can be effective at mmWave frequencies because DL and UL beamforming can be employed. In another example, strict time-domain separation of transmitter and receiver duty cycles may be used for the interference mitigation. In this instance, a node is provided with DL: UL frame patterns that prevent the nodes from operating at the same time. These frame patterns can be passed to the Relay-node via arguments embedded in SRv6 messages that the node controller can use to configure transceivers.

Aspects of the present disclosure described above, provide a Radio Access Network (RAN) implemented using SRv6 is a service graph, where CUs, DUs, and MTs are service function nodes that apply specific 5G functions to the traffic.

FIG. 6 shows an example of computing system 600, which can be for example any computing device making up a system network, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (central processing unit (CPU) or processor) and connection 602 that couples various system components including system memory 608, such as read-only memory (ROM) 610 and random-access memory (RAM) 612 to processor 604. Computing system 600 can include a cache 606 of high-speed memory 608 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include an output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., and when the code that defines such software is executed by the processor 604, it causes the system to perform a function. In some embodiments, a hardware service that performs a particular function can include the software component stored in a computer-readable medium in connection with the hardware components, such as processor 604, connection 602, output device 622, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A network access point, comprising:
a donor node including a central unit (CU) and at least one distributed unit (DU), wherein the CU is configured to perform functionalities associated with a first subset of layers of 5G signal processing layers and the at least one DU is configured to perform functionalities associated with a second subset of layers of the 5G signal processing layers; and a relay node including one or more mobile terminations (MTs) and one or more relay DUs, wherein:
each of the one or more MTs is configured to support a full signaling stack towards the one or more relay DUs, and
a top stack of each of the one or more MTs is a Radio Link Control (RLC) protocol configured to relay RLC Protocol Data Units (PDUs) to the one or more relay DUs and includes lower layers of the 5G signal processing layers,
wherein each of the donor node and the relay node includes an SRv6-capable router to provide a mesh functionality such that the donor node and the relay node operate as the network access point for one or more user equipment.

2. The network access point of claim 1, wherein the first subset of layers of a 5G signal processing stack includes service data adaptation protocol (SDAP) layer and packet data convergence protocol (PDCP) layer.

3. The network access point of claim 1, wherein the second subset of layers of a 5G signal processing stack includes Radio Link Control (RLC) layer, Medium Access Control (MAC), and Physical PHY) layers.

4. The network access point of claim 1, wherein each of the one or more MTs is configured to support a full signaling stack towards the one or more relay DUs.

5. The network access point of claim 4, wherein a top stack of each of the one or more MTs is a Radio Link Control (RLC) protocol configured to relay RLC PDUs to the one or more relay DUs and includes the lower layers of a 5G signal processing stack.

6. The network access point of claim 1, wherein the CU is configured to:
terminate traffic received at the CU from a 5G core; and
include Radio Resource Control (RRC) signaling functions in communications with the one or more user equipment and the relay node.

7. The network access point of claim 1, wherein each donor node is configured with one or more IPv6 addresses and a unique 10-bit BAP routing ID.

8. The network access point of claim 1, wherein each relay node is configured with:
a unique 10-bit BAP routing ID, wherein the unique 10-bit BAP routing ID is received by the relay node via RRC signaling; and
one or more IPv6 addresses acquired by the relay node during session establishment.

9. The network access point of claim 1, wherein the donor node and the relay node are configured with an SRv6 policy that defines one or more hops and behaviors along a respective SRv6 router in each of the donor node and the relay node.

10. The network access point of claim 9, wherein the behaviors are triggered upon receiving an incoming packet with a destination address (DA) matching a segment identifier (SID) identified on the respective SRv6 router.

11. A mesh-based radio access node comprising:
one or more donor nodes; and
one or more relay nodes, wherein:
each of the one or more donor nodes and the one or more relay nodes includes at least one SRv6 router, and
the one or more donor nodes and the one or more relay nodes are configured to communicate over a combination of wired and self-backhaul channels.

12. The mesh-based radio access node of claim 11, wherein each of the one or more donor nodes comprises:
a central unit (CU) and at least one distributed unit (DU), wherein the CU is configured to perform functionalities associated with a first subset of layers of 5G signal processing layers and the at least one DU is configured to perform functionalities associated with a second subset of layers of the 5G signal processing layers.

13. The mesh-based radio access node of claim 11, wherein each of the one or more relay nodes comprises:
one or more mobile terminations (MTs) and one or more relay DUs.

14. The mesh-based radio access node of claim 13, wherein each of the one or more MTs is configured to support full 5G signaling stack.

15. The mesh-based radio access node of claim 14, wherein each of the one or more MTs does not support any application function.

16. The mesh-based radio access node of claim 14, wherein:
each of the one or more MTs is configured to support the full 5G signaling stack towards the one or more relay DUs, and
a top stack of each of the one or more MTs is a Radio Link Control (RLC) protocol configured to relay RLC PDUs to the one or more relay DUs and includes lower layers of 5G signal processing layers.

17. The mesh-based radio access node of claim 11, wherein the one or more relay nodes are configured to prevent self-interference by performing time-domain separation of one or more transmitter and receiver duty cycles.

18. The mesh-based radio access node of claim 11, wherein the one or more relay nodes are configured to prevent self-interference using one of beamforming or null forming at each of the one or more relay nodes.

19. The mesh-based radio access node of claim 11, wherein the one or more donor nodes are configured to communicate with a 5G core.

20. The mesh-based radio access node of claim 11, comprising:
two donor nodes configured to provide redundant connectivity to a 5G core.
